(19) United States
(12) Patent Application Publication
(10) Pub. No.: US 2005/0092372 A1
(43) Pub. Date: May 5, 2005

(54) Flap valve

(76) Inventor: Rodney George Wade, Upper Coomera (AU)

Correspondence Address: NIXON & VANDERHYE, PC, 1100 N GLEBE ROAD, 8TH FLOOR, ARLINGTON, VA, 22201-4714, US

(21) Appl. No.: 10/958,378

(22) Filed: Oct. 6, 2004

(30) Foreign Application Priority Data
Oct. 29, 2003 (AU) 2003100893

(51) Int. Cl. F16K 15/03

(52) U.S. Cl. 137/527.6

(57) ABSTRACT

A flap valve is disclosed having a first spigot and a closure flap with an annular extension adapted to snugly fit within an outlet end of the first spigot and a flange integral with the annular extension adapted to circumscribe the outlet end. The flap valve having a second spigot of smaller diameter than the first spigot forming an extension to the first spigot.

### BACKGROUND OF THE INVENTION

This invention relates to flap valves and, in particular, to flap valves for water storage tanks and similar installations where venting is desirable.

Flap valves are incorporated on pipe outlets to enable liquid within the pipe to flow out but to prevent vermin such as cockroaches and other insects from entering the pipe when there is no flow of liquid through the pipe.

Existing flap valves comprise a planar disc of plastics or like material which is pivotally connected to the upper outer edge of a sleeve which is fitted to the pipe at it's outlet. Such valves have extremely poor sealing qualities and are not generally mosquito proof. This makes the valves unsuitable in a number of potential installations such as the overflow outlet on rain water storage tanks.

Existing flap valves are constructed such that the sleeve is able to be fitted to an outlet pipe of one particular diameter.

### OBJECTS OF THE INVENTION

It is therefore a primary object of the present invention to provide a flap valve which obviates or at least minimises these disadvantages and provides the public with a useful alternative.

It is a further object of the invention to provide a flap valve which enables venting of water storage tanks where water is used for human consumption. Such venting enables the stored water to breathe and is vital in keeping water fresh and free from contamination. This is becoming of concern to many health bodies around Australia and regulations to achieve such a goal are anticipated in the near future.

### SUMMARY OF THE INVENTION

According to the present invention there is provided a flap valve for sealing a pipe outlet, the flap valve having a first spigot and a closure flap with an annular extension adapted to snugly fit within an outlet end of the first spigot and a flange integral with the annular extension adapted to circumscribe the outlet end. Preferably, the flap valve has a second spigot of a smaller diameter than the first spigot forming an extension to the first spigot.

The longitudinal axis of the spigots are preferably offset and parallel to one another although, if desired the longitudinal axis may coincide and in which case the spigots are concentrically positioned with respect to one another.

Preferably, the flap valve is pivotally connected to an upper portion of the first spigot by means of a pivot pin or the like which is captured in a retainer projecting from the first spigot.

The shape of the annular extension and flange thus conform with the shape of the opening in the first spigot. Generally, the pipe will be circular in cross-section and in such a case it is preferred if the end of the pipe is cut at an angle to produce an essentially elliptical opening. The most preferred angle of cut will be in the region of 45° to 75°, most preferably about 60°. Such an elliptical opening will, of course, entail the use of an appropriate elliptical shaped flap valve. This shape has been found to produce the most effective seal.

The flap may have one or more extensions projecting beyond an edge thereof which serve to limit the extent to which the flap may be pivoted relating to the first spigot. Where the first spigot has an end at 45° the extension/s may be such that the flap may only pivot to about 75° relative to the free end of the spigot. In this way, when the flap is opened, it may return to its closed position relative to the free end of the first spigot under the influence of gravity.

In order to meet health requirements for the exclusion of mosquitoes, the mesh should suitably have a mesh opening of less than 1 mm. The mesh can be produced from injection moulded plastics material and be integrally formed with the annular extension and flange which is also preferably made of plastics material. Preferably, however, the mesh is manufactured from a non-corrosive metallic material such as copper, brass or stainless steel. The most preferred metallic mesh is stainless steel woven mesh having square apertures measuring approximately 0.95 mm. A preferred mesh diameter is approximately 0.315 mm. Such a mesh can also be integrally formed with the plastics material of the annular extension and flange by known injection moulding techniques.

The integral annular extension and flange construction ensures that an efficient vermin proof seal is formed with the end of the pipe since the annular extension extends from the exterior of the pipe where it is integrated with the surrounding flange, to the interior to, in essence, create a double seal with the inner side wall of the pipe and the very end section of the pipe.

The flap valve is preferably formed as a single unit and the second smaller spigot may fit over the end section of a tube of a corresponding external size. Where the flap valve is intended to fit over a tube of a size corresponding to the internal size of the first spigot, the second spigot and a small length of the first spigot may be cut from the remainder of the flap valve. The remainder of the first spigot may be fitted over a pipe having an outside diameter corresponding to the inside diameter of the remaining part of the first spigot.

In this way, the flap valve may be employed with pipes of two distinct sizes.

### DESCRIPTION OF THE DRAWINGS

A preferred embodiment of the invention will now be described with reference to the accompanying drawings, in which:

FIG. 1 is a plan view of a flap valve according to an embodiment of the invention shown with the flap open;

FIG. 2 is a side elevational view of the flap valve of FIG. 1;

FIG. 3 is a vertical sectional view of the flap valve shown in FIG. 1;

FIG. 4 is a top perspective view of the flap valve shown with the flap closed; and,

FIG. 5 is a bottom perspective view of the flap valve.

### DETAILED DESCRIPTION OF PREFERRED EMBODIMENT OF THE INVENTION

In all the drawings, like reference numerals refer to like parts.

The flap valve 5 as depicted has a flap 5A with an elliptical annular extension 10 with an integral flange 11 formed from injected moulded polyvinylchloride plastics material.

A mesh 12 of 304 grade 955 micron aperture stainless steel formed from 0.315 mm diameter wire is embedded in the flange during the production of the annular extension/flange, in a one-step operation.

The flap 5A is connected to an end-piece 13 of a first spigot, also formed from polyvinylchloride plastics material. The end-piece is dimensioned for slipping over the end of an over-flow or like pipe using a conventional pcv adhesive. The end-piece is tapered adjacent the flap 5A to an angel a of approximately 60° C.

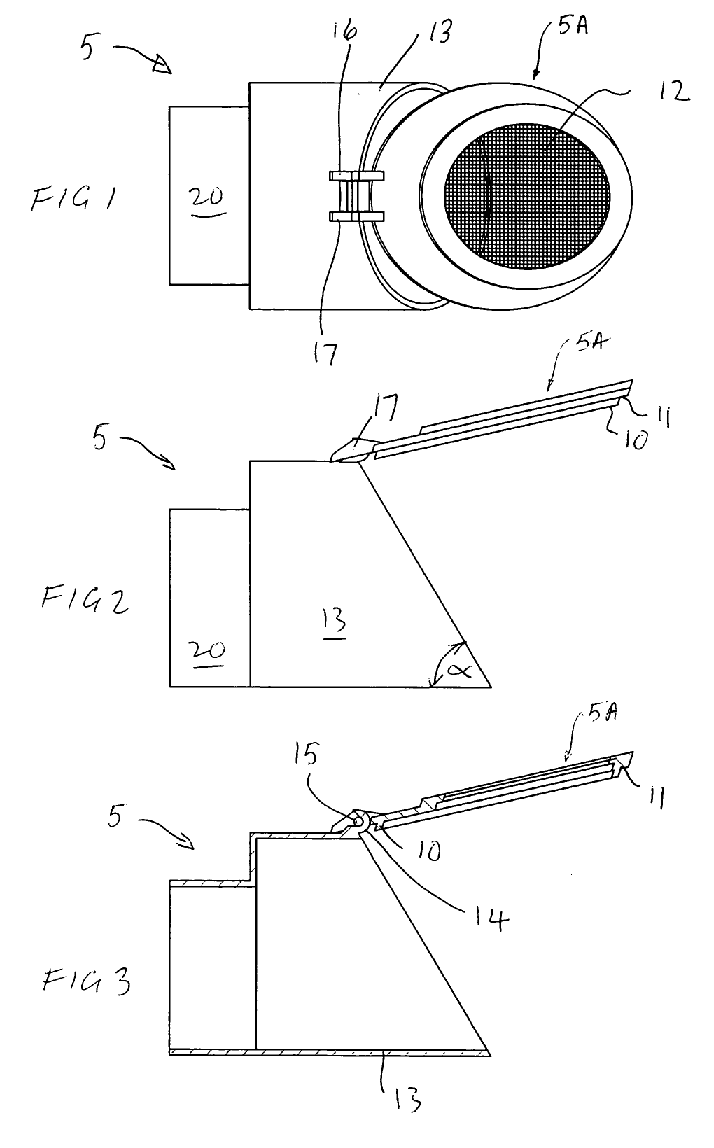

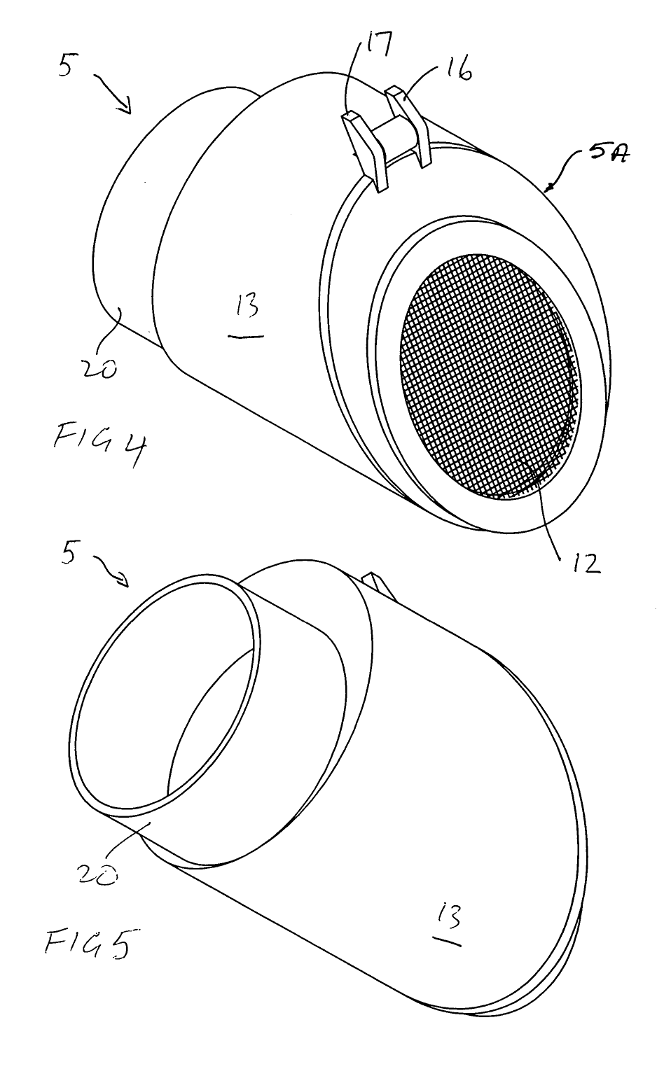

The top outer region of the end-piece includes an integrally moulded ridge 14 with partial internal bore to form a hook which accommodates a pivot pin 15. The pivot pin enables the flap 5A to be connected by means of the flange 11 to the end-piece by virtue of a pair of ribs 16, 17 formed in the periphery of the flange. The ribs 16, 17 form extensions which limit the extent to which the flap 5A may pivot. This limit is shown in FIG. 2.

A second spigot 20 forms an extension to spigot 13. Spigot 20 is of a smaller size than spigot 13 and has its central axis offset relative to the central axis of the spigot 13.

When the flap valve 5 is intended to be fitted to a pipe of a corresponding size to spigot 20, spigot 20 may be fitted to that pipe. When it is intended to use the flap valve with a pipe of a size corresponding to the size of spigot 13, spigot 20 may be cut from the flap valve. In this way the flap valve may be used with pipes of two distinct sizes.

The projections 16, 17 limit the extent to which the flap 5A may be opened and the flap 5A may return to its closed position under the influence of gravity.

The arrangement provides a double sealing action between the flap and the spigot end-piece. This ensures that vermin such as insects cannot enter the end-piece and provides a significant improvement over conventional seals.

The use of mesh on the flap instead of a convention solid end wall enables venting of the pipe and this is important for water stored for human consumption to ensure that the water remains potable.

Whilst the above has been given by way of illustrative example of the invention, many modifications and variations may be made thereto by persons skilled in the art without departing from the broad scope and ambit of the invention as herein set forth.

1. A flap valve for sealing a pipe outlet, the flap valve having a first spigot and a closure flap with an annular extension adapted to snugly fit within an outlet end of the first spigot and a flange integral with the annular extension adapted to circumscribe the outlet end.

2. The flap valve of claim 1 wherein the flap incorporates an insect control screen.

3. The flap valve of claim 1 wherein central longitudinal axis of the spigots are parallel and offset relative to one another.

4. The flap valve of any one of claims 1 wherein the flap has extensions projecting from it which limit the extent to which the flap may be moved relative to the first spigot.

5. The flap valve of claim 1 having a second spigot of smaller diameter than the first spigot and forming an extension to the first spigot.

6. The flap valve of claim 1 wherein the closure flap is coupled to the first spigot by a pivot pin and the first spigot has a retainer projecting from the first spigot for capturing the pivot pin.

7. The flap valve of claim 6 including one or more projections projecting from the flap beyond an edge thereof which limit the extent to which the flap may pivot relative to the first spigot.

8. The flap valve of claim 7 wherein the flap may pivot about 75° relative to the outlet end of the first spigot.
